(19) United States
(12) Patent Application Publication
(10) Pub. No.: US 2015/0186941 A1
(43) Pub. Date: Jul. 2, 2015

(54) Portal for Sending Merchant Offers to Users and User Interactions with Merchant Offers

(71) Applicant: RADIUS NETWORKS INC., WASHINGTON, DC (US)

(72) Inventors: John N. Anthony, Skillman, NJ (US); Stephanie Dressel, Chicago, IL (US); Tamara Lynne Casey, Fallon, NV (US); Andrea Louise Tong, San Francisco, CA (US)

(21) Appl. No.: 14/142,429

(22) Filed: Dec. 27, 2013

(51) Int. Cl. G06Q 30/02

(52) U.S. Cl. CPC G06Q 30/0257; G06Q 30/0242

(57) ABSTRACT

An online advertisement system provides an advertisement publishing portal for merchants to target specific users based on merchant-defined factors as well as providing users with ways of customizing the selection of advertisements that are displayed on an advertisement application. Merchants can set conditions for the publication of an advertisement. Once the conditions have been met for publishing an advertisement, the advertisement is transmitted to selected users. Users are able to set preferences for allowing advertisements from certain merchants to be saved on the user device. Based on the merchants and the categories associated with the advertisements, advertisements may be blocked, saved or used to generate a push notification to alert the user of the saved advertisements. Merchants may track user actions related to the published advertisements through real-time tracking and analytics offered through the portal.

### BACKGROUND

1. Field of Art

This invention generally relates to the field of advertisement notification, and more particularly to providing a portal allowing merchants to push notifications to client devices.

2. Description of the Related Art

Online advertisement has become increasingly popular in recent years as Internet usage has grown exponentially. By advertising online, merchants are able to reach a greater audience at much less of an investment cost. Smaller businesses that may otherwise not be able to pay for traditional television or newspaper advertisement slots are now able to advertise to the public at a manageable cost. To further entice customers to purchase from them, merchants are also publishing specific types of advertisements, such as offers, promotions, event notifications and the like, to the public.

Some businesses have capitalized on the growing trend of online advertising by creating applications, such as mobile applications, to be used as advertisement distribution platforms. These applications receive or collect advertisements from publishers and consolidate the advertisements in a central application where the user is able to easily view the variety of advertisements that are available. However, with the increasing amount of online advertisements available, users are frequently inundated with the amount of advertisements that they have to sort through to find one that fits their desires. Both the user and the business suffer when users are unable to find an advertisement that appeals to them and businesses are unable to generate additional revenue from their advertisements.

### SUMMARY

An online advertisement system provides an advertisement publishing portal for merchants to target specific users based on merchant-defined factors as well as providing users with ways of customizing the selection of advertisements that are displayed on an advertisement application. In an embodiment, the merchant specifies parameters, such as time and location, in addition to the advertisement itself during the publication process. The parameters indicate when and to whom the advertisement should be released to. When advertisements are sent to a server for publication, the server checks whether the conditions specified by the merchant have been met prior to advertisement publication. Based on the results of the check, the server may publish the advertisement to the targeted users. Each user may also specify separate parameters, such as allowed merchants, selected categories and current location, for filtering the received merchant advertisements. Advertisements that remain after the filtering are stored in a local storage database and may be selected for push notifications to the user.

In an embodiment, the merchant is able to track the progress of the published advertisements through real-time tracking and analytics. When advertisements are published, merchants are able to know user actions in response to the received advertisements, such as which users have viewed and redeemed the received advertisements. In some embodiments, the user actions are also tied to the user's current location. The user action information is transmitted back to the server, which generates the real-time tracking and analytics that is sent to the merchant for display.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

Figure (FIG.) 1 illustrates an example environment of an advertisement publishing portal for merchants to target specific users in various ways as well as to provide users with ways of customizing the selection of advertisements that are displayed on an advertisement application, in accordance with an embodiment.

FIG. 2 is an example high-level block diagram illustrating a detailed view of an advertisement management server, according to one embodiment.

FIG. 3 is an example high-level block diagram illustrating a detailed view of a client device, according to one embodiment.

FIG. 4 is an interaction diagram illustrating the data flow between the merchant device, advertisement management server and client device, according to one embodiment.

FIG. 5 is a flow diagram illustrating the publication of an advertisement at an advertisement management server, according to one embodiment.

FIG. 6 is a flow diagram illustrating the processing of a received advertisement at a client device, according to one embodiment.

FIG. 7 illustrates components of an example machine able to read instructions from a machine-readable medium and execute the instructions in a processor (or controller), according to an embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed. It is noted that wherever practicable, similar or like reference numbers may be used in the figures and may indicate similar or like functionality.

### Overview

Embodiments relate to providing a content items publishing portal for merchants to target specific users based on merchant-defined factors and for users to customize the selection of content that is available for viewing on a content processing program. As used herein, content items include various types of content, such as music, TV programs and advertisements/events. One embodiment relates to providing an advertisement publishing portal for merchants to target specific users based on merchant-defined factors as well as providing users with ways of customizing the selection of advertisements that are available for viewing on an advertisement application. As used herein, an advertisement application refers to any program or object installed on a computing device that provides users with the capability to communicate with a server via a network to download and view advertisements. The advertisement application manages advertisements/events, offers, notifications and promotions(hereon collectively referred to as “advertisement”). The advertisement application may be implemented as a software program, client, widget and applet.

In some embodiments, a merchant connects with a server to create, upload, modify or delete the merchant's advertisement/event. The merchant is also presented with an interface to create, complete or repeat an advertisement when the merchant connects with the server. Using this interface, the merchant can store an advertisement on the server for publishing to targeted audiences that are also connected with the server. The merchant is able to specify a range of parameters for limiting the audience that receive the advertisement. For example, the merchant can set the time, location, users, quantity and the like for indicating the conditions of an advertisement publication. In an embodiment, the merchant is able to track the publication, viewing and redemption of the advertisement. For example, the merchant is able to determine the number of users performing an action related to the published advertisement, observe when and where the action is performed and view a real-time tracking/analytics for analyzing historical published advertisements. These advertisement publication parameters beneficially allow merchants to target an audience that has the best chance of converting a published advertisement into a complete transaction at the merchants' stores. The real-time analytics also allows merchants to analyze the user action patterns in response to a published advertisement.

In some embodiments, a user connects to the server through an advertisement application to download and view published advertisements. The advertisement application generates a user interface for the user to view advertisements. In an embodiment, advertisements are downloaded to the application upon the user's request. In another embodiment, users are able to define parameters, such as their location, a specific time frame, specific categories and specific merchants, for filtering advertisements and indicating which advertisements receive a push notification on the user's client device. Users are able to select, unselect, favorite and block individual merchants or categories of merchants. Categories may be defined by a commonality, such as a product type, store type, merchant ratings, user reviews, store location and intended target consumer. Categories may comprise one or more merchants grouped together according to their commonality. Using these parameter filters, users are able to receive only the advertisements that they want, which prevents users from having to sift through a long list of unwanted advertisements.

### System Architecture

FIG. 1 is an example environment of an advertisement publishing portal for merchants to target specific users in various ways as well as providing users with ways of customizing the selection of advertisements that are displayed on an advertisement application, in accordance with an embodiment. The operations described herein may be performed by one or more computing systems, such as client device 120. Referring to FIG. 1, the environment 100 includes one or more merchant devices 105a, 105b, 105c (referred to collectively as “merchant device 105”), a network 110, server 115, and multiple client devices 120a, 120b, 120c (referred to collectively as “client device 120”). The merchant devices 105 may be in contact with one or more client devices 120 and one or more server 115 via the network 110. Only three merchant devices 105, one server and three client devices 120 are shown in FIG. 1 for purposes of clarity, but those skilled in the art will recognize that typical environments can have multiple servers 115 and varying numbers of merchant devices 105 and client devices 120.

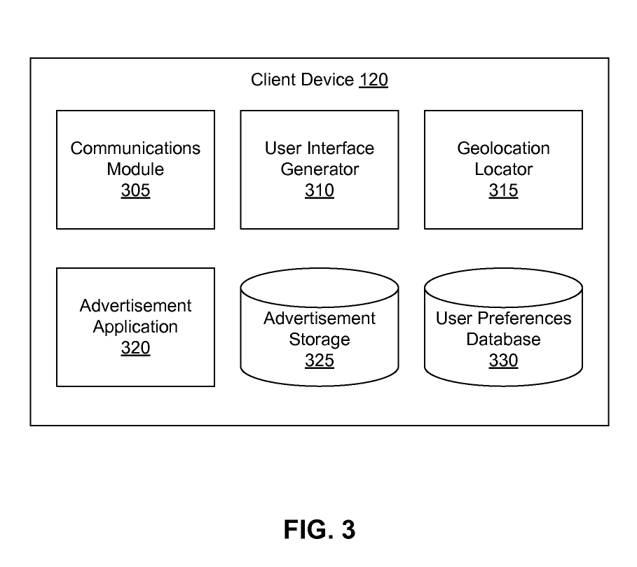

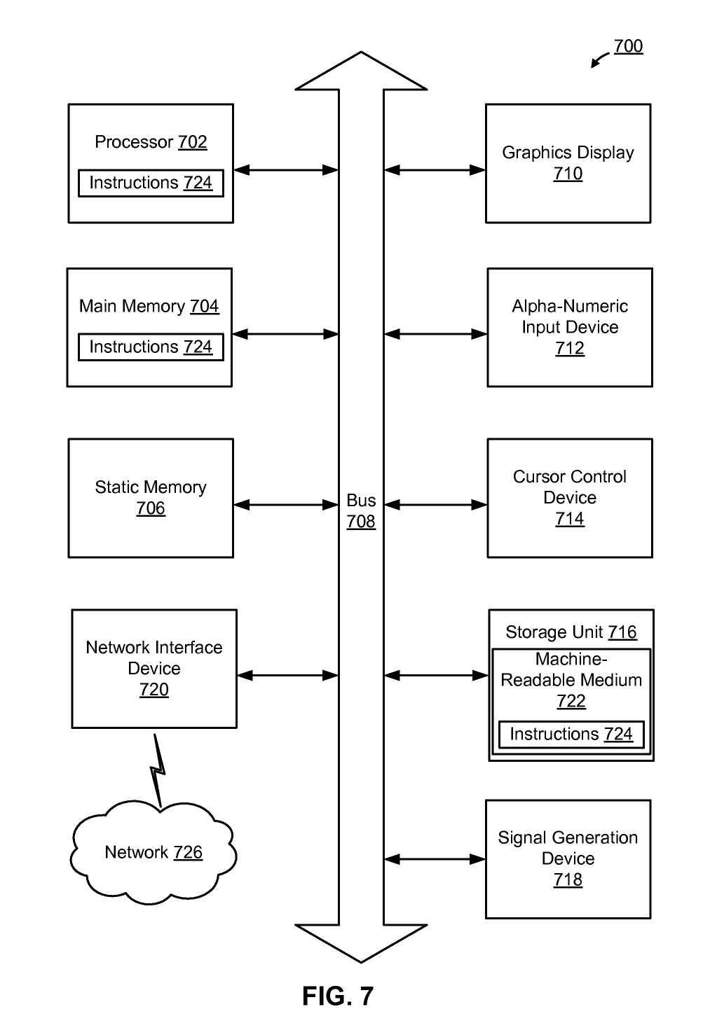

A merchant device 105 is a computing device capable of processing data as well as transmitting and receiving data via a network 110. For example, a merchant device 105 may be a mobile device, smart phone, tablet computing device, desktop computer, a laptop computer, a smart television, a set-top box, a game console or any other device having computing and data communication capabilities. A merchant device 105 is coupled to a network 110, which may comprise any combination of local area, cellular, wireless, and/or terrestrial communication systems. Because the components of a merchant device 105 is similar to components of a client device 120, descriptions of the client device 120 in FIGS. 3 and 7 may also apply to the merchant device 105.

The network 110 enables communications between the various entities of the environment 100. In one embodiment, the network 110 uses standard communications technologies and/or protocols. Thus, the network 110 can include links using technologies such as Ethernet, Wireless Fidelity (WiFi) (e.g., 802.11), worldwide interoperability for microwave access (WiMAX), 3G, Long Term Evolution (LTE), digital subscriber line (DSL), asynchronous transfer mode (ATM), InfiniBand, PCI Express Advanced Switching, etc. Similarly, the networking protocols used on the network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 110 can be represented using technologies and/or formats including the hypertext markup language (HTML), the extensible markup language (XML), JavaScript Object Notation (JSON) etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 110 can also include links to other networks such as the Internet.

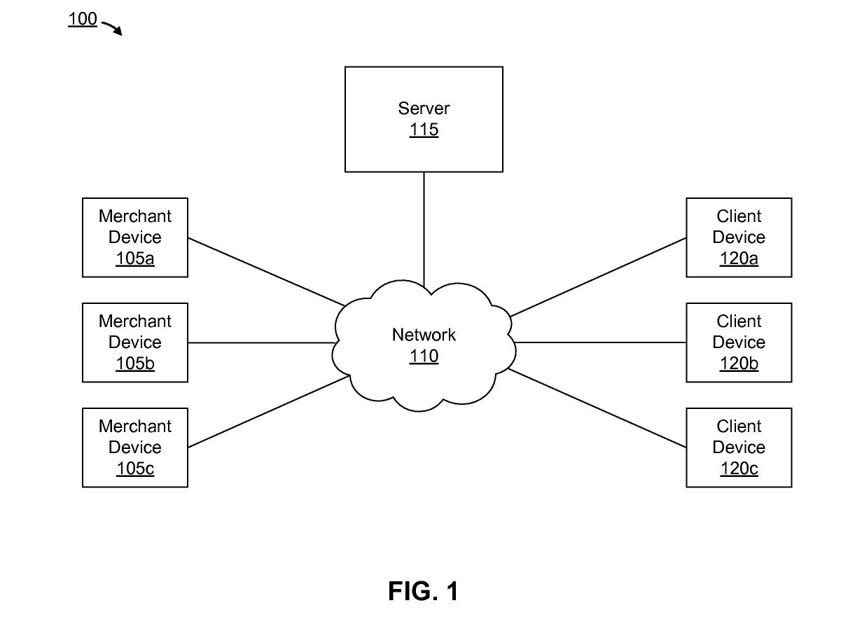

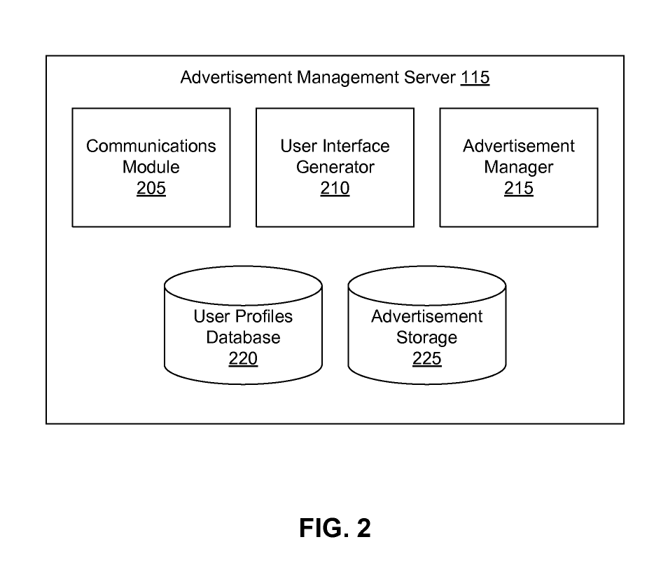

The server 115 is a computer system configured to store, receive, and transmit data to merchant devices 105 and client devices 120 via a network 110. The server 115 may include a singular computing system, such as a single computer, or a network of computing systems, such as a data center or a distributed computing system. In an embodiment, the server 115 is a content or data server providing information to merchant devices 105 or client devices 120. For example, the server 115 may be an advertisement management server that receives information from associated merchant devices 105 and associated advertisement applications on the client devices 120. The server 115 may store and process this information before transmitting the information to merchant devices 105 or client devices 120. The server 115 may actively send information to advertisement applications on client devices 120. For example, the server 115 may receive advertisement information from a merchant device 105 or have advertisements stored for publication. Under the conditions defined by the merchant, the server 115 may publish advertisements to advertisement applications on client devices 120. The client devices 120 may also periodically request published advertisements from the server 115 without the server 115 having to automatically push the advertisements to the client devices 120. The components and the structure of server 115 are described in further detail below with reference to FIG. 2.

The client devices 120 are similar to the merchant devices 105. The client devices 120 are also computing devices capable of processing data as well as transmitting and receiving data via a network 110. The primary difference between a client device 120 and a merchant device 105 is that client devices 120 are recipients of published advertisements that are uploaded by merchant devices 105. For example, a merchant uploads an advertisement through an interface, such as an application web interface, to a server 115. The server 115 publishes the advertisement by releasing it for viewing to client devices 120. As such, descriptions of software, hardware, memory, and modules in merchant device 105 also pertain to client devices 120 and vice versa.

### Advertisement Management Server System

FIG. 2 is an example high-level block diagram illustrating a detailed view of an advertisement management server 115, according to one embodiment. The server 115 comprises one or more computing devices that store information on a plurality of users, merchants and advertisements that are associated with the server 115. In the embodiment illustrated in FIG. 2, the server 115 includes a communications module 205, a user interface generator 210, an advertisement manager 215, user profiles database 220 and advertisement storage 225. Other embodiments of the server 115 may have different and/or additional components or may include fewer components than those shown in FIG. 2.

The communications module 205 enables the server 115 to communicate with other devices connected to the network 110. In an embodiment, the communications module 205 facilitates the communications between the network 110 and the server 115, transforming data from the server 115 into transmission protocols that can be sent through the network 110. For example, the communications module 205 may convert the data to or from wireless signals that may be transmitted via cellular, Wi-Fi, Bluetooth or other wireless mediums. The communications module 205 may also convert the data to or from Internet protocols such as TCP/IP, UDP, HTTP, SMTP, FTP, SSL, TLS, VPN, IPsec and so forth.

The user interface generator 210 creates an interface that can be transmitted over the network 110 to a merchant device 105 or a client device 120. Through the generated user interface, users are able to input and view information available on the server 115, such as advertisements, profile information and settings. For example, the user interface generator 210 may create a browser interface for a merchant to use while uploading an advertisement or specifying parameters for the advertisement. The user interface generator 210 may also detect what type of device (e.g., desktop computer, laptop computer, PDA, tablets, smartphones, touch-sensitive displays, gaming consoles and the like) and format the generated user interface according to the type of the device. In another example, the user interface generator 210 may also generate the advertisement displays for the advertisement application on client devices 120 according to the merchant's specifications.

The advertisement manager 215 receives information from a merchant regarding an uploaded advertisement. For example, the advertisement manager 215 may receive information on an advertisement's title, sponsor, location, time, associated image/logos, description, fine print and conditions from the merchant. The advertisement manager 215 may also receive information regarding conditions for publishing the advertisement from the merchant. These information may include the location a user needs to be to receive the advertisement (e.g., via GPS, cellular-aided positioning, Wi-Fi SSID/locator and the like), the time to publish the advertisement (e.g., a pre-defined time or a time relative to another event occurring), specific users to publish to (e.g., based on the user favoriting the merchant on the advertisement application, the user participating in the merchant's loyalty program, the merchant selecting the specific user and the like), and the quantity of advertisement to release before stopping advertisement distribution. Upon fulfillment of one or more of these conditions according to the merchant's instructions, the advertisement manager 215 distributes the associated advertisement to the client devices 120 for display to users. The advertisement manager 215 may also send a notification to the merchant devices 105 indicating the distribution of the advertisement. In some embodiments, the advertisement manager 215 may also monitor the real-time tracking and analytics of the published advertisements, including which users view/redeem an advertisement, when the users view/redeem the advertisement, where the users are when they viewed/redeemed the advertisement, and also historical analysis of published advertisements.

The user profiles database 220 is a repository for user and merchant related information that the server 115 receives or generates. User information may include, but are not limited to, names, email addresses, age, gender, advertisement viewing/redemption histories, favorited merchants, selected categories, blocked/unselected merchants/categories, user system specifications, user system settings, location identifiers, network connection properties and other data. Favorited merchants are merchants that the user likes or especially wants to receive advertisements from. Blocked merchants are merchants that the user does not want to receive any advertisements from. Unselected merchants are merchants that the user has taken no particular actions in labeling them. In an embodiment, when a user registers for an account on the advertisement application in a client device 120, the advertisement application transmits the information as a user profile to the user profiles database 220 for storage. Other information, such as information relating to the user's viewed/redeemed advertisements, may also be stored with the user's profile in the user profiles database.

The advertisement storage 225 also stores objects related to advertisements. In an embodiment, the advertisement information, merchant-defined parameters for the advertisement, the real-time tracking history and analytics information and the like are stored in the advertisement storage 225. After merchants upload advertisements onto the server 115, the advertisements are stored in the advertisement storage 225 until conditions are met for the advertisements' publication or distribution to client devices 120. Once the advertisements are to be published, the advertisement manager 215 retrieves the advertisements from the advertisement storage 225 and transmits them to the client devices 120. In an embodiment, a copy of the advertisements also remains in the advertisement storage 225 for client devices 120 to request.

### Advertisement Application Client Device System

FIG. 3 is an example high-level block diagram illustrating a detailed view of a client device 120, according to one embodiment. The modules, components and operations depicted in FIG. 3 may be run on a computing system, such as a merchant device 105 or a client device 120. For the purpose of clarity, the computing system described in FIG. 3 will be for the client device 120, but merchant devices 105 may have the same or similar structure and functionality. The client device 120 illustrated in FIG. 3 comprises a communications module 305, user interface generator 310, geolocation locator 315, advertisement application 320, advertisement storage 325 and user preferences database 330. Other embodiments of the client device 120 may have different and/or additional components or may include fewer components than those shown in FIG. 3.

The communications module 305 enables the client device 120 to communicate with other devices connected to the network 110. In an embodiment, the communications module 305 facilitates the communications between the network 110 and the client device 120, transforming data from the client device 120 into transmission protocols that can be sent through the network 110. For example, the communications module 305 may convert the data to or from wireless signals that may be transmitted via cellular, Wi-Fi, Bluetooth or other wireless mediums. The communications module 305 may also convert the data to or from Internet protocols such as TCP/IP, UDP, HTTP, SMTP, FTP, SSL, TLS, VPN, IPsec and so forth.

The user interface generator 310 creates an interface for display to the user based on the client device 120 and the information to be displayed. In an embodiment, the user interface generator 310 receives information from other modules in the client device 120 or from the network 110 and processes the information into a visual format. The user interface generator 310 sends the generated user interface to a graphics generator to produce the visual interface. The user interface generator 310 also receives input from the user, such as physical (e.g., button presses, screen touches and movements, audio (e.g., voice) and visual (e.g., image captures, videos), and interprets the input according to the data displayed. The converted data can be used by other modules in the client device 120.

The geolocation locator 315 determines the client device's geographical positioning and, by extension, where the user of the client device 120 is located. In an embodiment, the geolocation locator 315 may determine the client device 120 location through multilateration of radio signals from network towers, GPS, networks, cellular-aided locator, Wi-Fi identifiers or SSID, user-inputted location or a combination of these methods to detect where the client device 120 is. The location determined by the geolocation locator 315 may be used by the advertisement application 320 to determine which advertisements to receive or push to the user's attention. For example, a user may only want to receive advertisements from merchants within a set radius, area, city, zip code or blocks away from the user's current location. The location may also be used by the merchants to determine where and when to publish their advertisements. For example, the merchant may restrict an advertisement's release to users that are within a predefined radius, area, city, zip code, block or store.

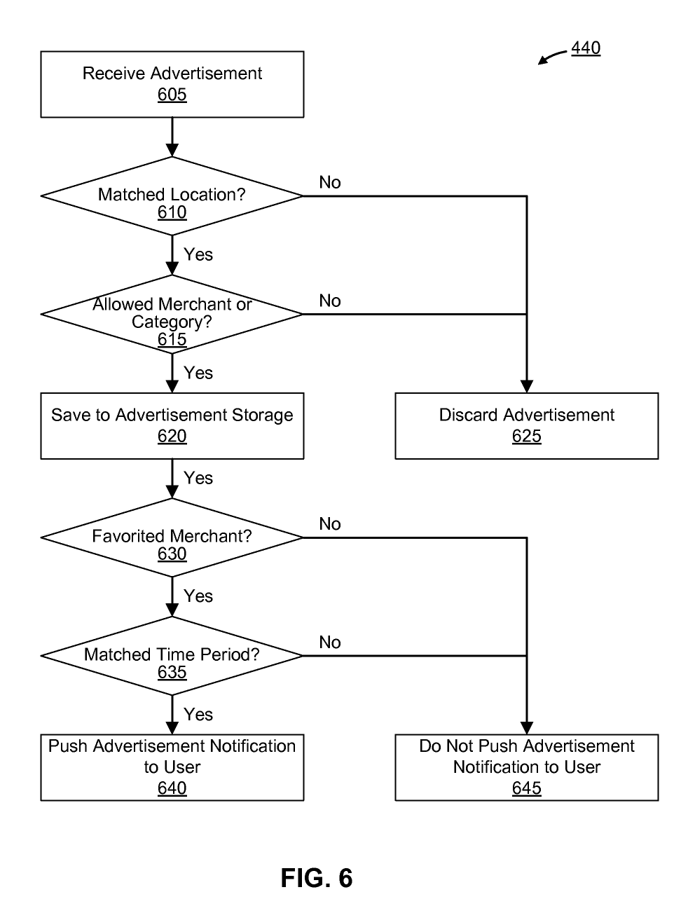

The advertisement application 320 is a program that interfaces between the server 115 and the user to provide the user with the ability to access available published advertisements. In an embodiment, the advertisement application 320 requests the user to input personal information and preferences in order to set up an account for the user. The user may also input favorited merchants, favorited categories, or blocked merchants into the advertisement application 320 as well to define who the user wants to receive advertisements from. The advertisement application 320 may further filter received applications by transmitting the user's location periodically to the server 115. For important advertisements that are received, the advertisement application 320 may generate a push notification (e.g., banners, visual alerts, alert sounds, vibrations and the like) to alert the user of the received advertisement. The filtering and notification process of the advertisement application 320 is described in further detail in FIG. 6. In some embodiments, the advertisement application 320 may also request for additional advertisements from the server 115 in response to a user request. For example, the advertisement application 320 may present the user with advertisements that are automatically sent to and filtered at the client device 120. The advertisement application 320 may allow the user to access additional advertisements available on the server 115 through search or browsing interfaces.

Similar to the advertisement storage 225 in FIG. 2, the advertisement storage 325 in FIG. 3 is a repository for objects related to advertisements. In an embodiment, the advertisement storage 325 receives advertisement information from the server 115 and stores it in the advertisement storage 325. In an embodiment, the advertisements can be retrieved from the advertisement storage 325 when requested by the advertisement application 320. In another embodiment, the advertisements stored in the advertisement storage 325 may be automatically retrieved and used as part of a push notification or alert to the user. In some embodiments, the advertisements may remain in the advertisement storage 325 indefinitely, until the advertisement storage 325 receives an indication to delete the advertisement. In other embodiments, the advertisements may remain in the advertisement storage 325 for a predetermined time period before automatically being removed.

The user preferences database 330 stores preferences that the user has inputted into the advertisement application 320. In an embodiment, the user preferences database 330 may store a list of the user's favorited merchants, selected/favorited categories, unselected categories, blocked merchants, advertisement filtering parameters (e.g., distance from current location, and time period for receiving advertisements). These user preferences are retrieved and used by the advertisement application 320 to determine which published advertisements to block, receive or alert the user about.

### Advertisement Publication Process

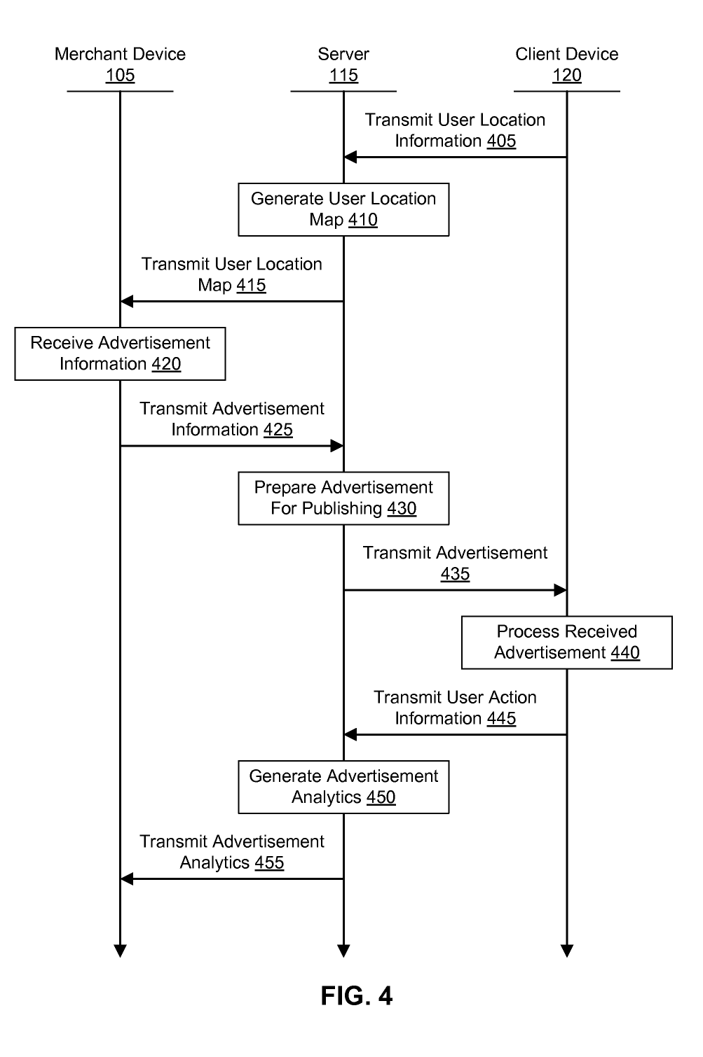

FIG. 4 is an interaction diagram illustrating the data flow between a merchant device 105, an advertisement management server 115 and a client device 120, according to one embodiment. Other embodiments of the data flow may comprise additional or fewer steps than those shown in FIG. 4.

To provide merchants using merchant devices 105 with real-time tracking of advertisement application 320 users, the client device 120 may periodically transmit 405 user location information to a server 115. For example, the server 115 may ping or request the client device 120 location once every 10 minutes. The client device 120 may respond to the server requests by transmitting 405 the location information. Depending on the user's privacy preference settings, the client device 120 may ignore the server requests for the user location information. In the instance that the request is ignored, the server 115 is unable to indicate to the merchant where that user is located.

With the received user location information, the server 115 generates 410 a user location map that is transmitted 415 to the merchant device 105. The user location map displays a map of an indicated area, such as the vicinity of the merchant's store, and overlays pointers or icons on the map to show where each client device 120 is located. In some embodiments, users that have favorited the merchant may be displayed with a special icon. The generated map provides merchants with a real-time tracking method for observing where potential customers may be located. With each user location request, the map is refreshed to show the current location of the user. To generate a more updated user location map, the server 115 may request the client device's location at a higher frequency. In some embodiments, the generated map may be restricted to primarily an area around the merchant's store location. In other embodiments, the generated map may encompass a greater area, such as an entire state or country, and display icons for where users of advertisement application 320 are currently located. In another embodiment, the generated map may restrict which users are shown based on client device settings that restrict the completion of the transaction. In other words, the server 115 tracks the client device settings that a user sets in order to receive an offer from the merchant. The generated map can be restricted to show only those users that would actually receive the offer to be displayed on the client devices 120.

When the merchant decides to release or upload an advertisement, the merchant inputs the necessary information into the merchant device 105. In an embodiment, some advertisement information that the merchant device 105 may receive 420 from the merchant include advertisement titles, locations, time periods, quantity, description, fine print, logo, associated images, links, associated advertisements and so forth. Merchants may be able to specify detailed conditions associated with the targeted client devices 120 to receive the advertisement. For example, merchants may specify a certain area where users of the advertisement application may receive a published application. The area may encompass locations within a specific radius from the merchant's store, a city, a particular zip code, a merchant-defined area, an area within the merchant's store and the like. The merchant may also specify to release the advertisement to only users that have favorited them or based on other criteria specified by a combination of users, merchants or advertisement publishing systems. Furthermore, the merchant may specify a certain time to publish the advertisement, such as a pre-defined time, a time dependent on another event (e.g., after the end of a baseball game, after a tour bus arrival, ten minutes prior to a store opening, etc.), a time dependent on certain conditions being met (e.g., less than twenty people visiting the store in a day, more than five people in the merchant's store area, etc.), a defined time period, and the like. In some embodiments, the merchant can also specify the quantity of advertisements to release. Once the number of available advertisements have been viewed or redeemed, users may receive an additional notification from the server 115 stating that the advertisement is completed. In some embodiments, the merchant may also indicate that the user is allowed to post/share the event on other online locations, such as on social networking systems.

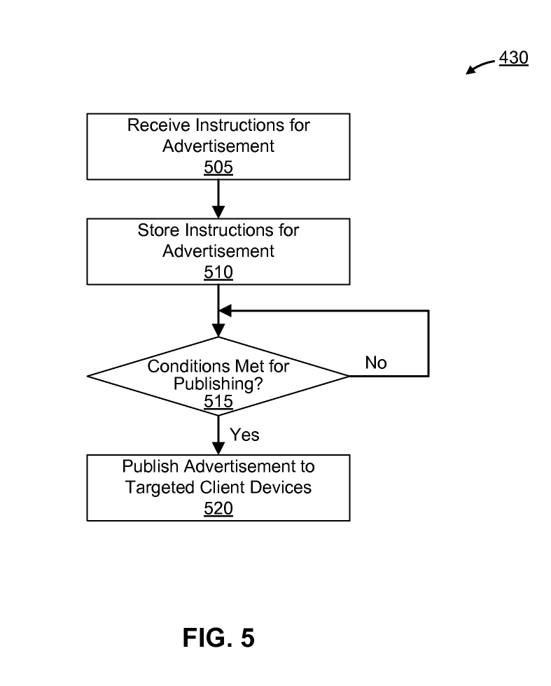

After the merchant device 105 has received 420 the advertisement information, the merchant device 105 transmits 425 the advertisement information to the server 115. The server 115 processes the received information and prepares 430 the advertisement for publishing. In an embodiment, this may involve generating advertisement trackers and indices to store and monitor the advertisements prior to and after publication. More information on preparing 430 the advertisement for publishing is described in FIG. 5. When the advertisement meets the conditions for publication, the server 115 transmits 435 the advertisements to targeted client devices 120 based on the merchant's instructions.

Upon receiving the transmitted advertisement, the client device 120 processes 440 the received advertisement. In an embodiment, the received advertisement is filtered dependent on the user's preferences and set parameters so that the advertisements stored on the client device 120 are desired by the user. In other embodiments, the server 115 filters the advertisements to be sent to the users. Some of the parameters can include matching user location to the received advertisement's target location and allowing specific merchants/categories. In some embodiments, the client device 120 may also generate a push notification to alert the user of specific advertisements that are of high interest to the user. More details on the advertisement processing 440 are described in FIG. 6. In some embodiments, the user may manually request the advertisement application 320 to pull advertisements from the server 115 that are not already on the client device 120.

When the client device 120 receives the advertisement from the server 115, the client device 120 stores it in an advertisement storage 325 until the user views the advertisement. In an embodiment, the user may take different actions to take when an advertisement is received. The user may choose from actions such as view, redeem, store, delete, ignore and share When the user looks through the received advertisement, the client device 120 may display the advertisements in a list or associated with merchant stores on a map. The user is able to conveniently sort through a set of received advertisements and find a desired advertisement quickly. When the user chooses to redeem the advertisement, the advertisement application 320 may display a quick response (QR) code, barcode, message or name for the user to use when redeeming the advertisement in the merchant's store. The advertisement application 320 may also utilize other means of indicating to a store employee that the user has redeemed the advertisement. In response to the various actions that the user takes in association with the advertisement, the client device 120 may transmit 445 user action information to the server 115 for storage and analysis.

Using the received user action information, the server 115 generates 450 advertisement analytics and real-time tracking information for display to the merchant. For example, the server 115 may generate maps showing the historical user viewing and redemption locations for each of the previously published advertisements. The server 115 may also generate real-time maps showing where each user is located and update the map as each user views and/or redeems an advertisement. In an embodiment, the server 115 may also generate a timeline to show times of days or week when users perform an action on a published advertisement. Once the advertisement analytics have been transmitted 455 to the merchant device 105, the merchant can use the received information to more efficiently plan the release of advertisements.

FIG. 5 is a flow diagram illustrating the publication of an advertisement at an advertisement management server, according to one embodiment. In an embodiment, the steps shown in FIG. 5 are performed by a server 115, similar to one in FIG. 1. After a server 115 receives 505 transmitted advertisement information 425, the server 115 begins to prepare 430 the advertisement for publishing. In an embodiment, this includes storing 510 the instructions associated with the advertisement in the advertisement storage 225. The stored instructions are available for the advertisement manager 215 to retrieve and process for determining parameters for publishing an advertisement. The advertisement manager 215 determines the time and targeted users to publish an advertisement to based on the stored instructions. When the parameters for publications set by the merchant are met 515, the advertisement manager 215 publishes 520 the advertisement to the appropriate targeted client devices 120. Otherwise, the advertisement manager 215 continues to monitor the advertisement and other received information until the conditions for advertisement publication have been met.

FIG. 6 is a flow diagram illustrating the processing of a received advertisement at a client device 120, according to one embodiment. In an embodiment, the steps shown in FIG. 6 are performed by a client device 120, similar to one in FIG. 1, and are an elaboration of the processing 435 of a received advertisement step in FIG. 4. It is noted that the steps described in FIG. 6 may be performed in an order different than the order shown in FIG. 6. Some embodiments may also omit certain steps or include additional steps.

After a client device 120 receives 605 an advertisement from a server 115, the client device 120 sorts and filters the advertisements so that allowed advertisements are stored on the client device 120 while other advertisements are saved, but blocked from being viewed by the user on the client device 120. The sorting and filtering is based on user preferences that a user defines in the advertisement application 320. As previously described, a user may define locations, merchants, categories and time periods associated with advertisements that the user wants to receive. Based on a subset of these factors, the client device 120 may also generate a push notification to alert the user of the received application.

A user can specify a location associated with the advertisements that the user wants to receive. In an embodiment, the location may be a certain radius around the user or the current city that the user is in. The location may also be a city or zip code that the user specifies, such as a city that is across the country from the user. For example, the user may currently be located in San Francisco but desires to receive advertisements from merchants located in Chicago. The user has the option to input Chicago as the user's location so that the user receives advertisements targeted at a Chicago audience. If received advertisements originate from merchants that are located within the specified location, then the client device 120 is able to match the location 610 step in the filtering process and the advertisement is saved 620. If the received advertisements do not match the specified location 610, in an embodiment, the advertisement is discarded 625. In other embodiments, the advertisement may be designated as spam or transferred to a designated storage location on the client device 120.

Users can also filter advertisements through merchant identifiers such as favorited merchants, unselected merchants and blocked merchants. Client devices 120 can receive advertisements from merchants that are “allowed” (e.g., unselected or favorited). Advertisements from allowed merchants 615 are saved 620 in the client device 120 while those from merchants not allowed 615 are discarded 625 or designated as spam.

Users can also filter advertisements based on category identifiers such as selected, unselected or blocked categories. A client device 120 is able to receive advertisements from categories that have been selected while advertisements from other categories are redirected or discarded 625. In an embodiment, an exception to this is favorited merchants. Advertisements that have been favorited are saved 620 to the advertisement storage, regardless of the merchant's associated category identifier.

Once saved 620 to the advertisement storage, the user may request the advertisement application 320 to retrieve the saved advertisement for viewing and/or redemption. In an embodiment, advertisements from merchants that the user particularly likes based on the user-defined factors may be used to generate push notifications 640. A push notification can be used to actively notify the user of a newly received advertisement or other related advertisements. As described previously, a push notification may comprise a visual alert (e.g., banners, icons, flashes), audio alert or physical alert (e.g., vibrations).

In an embodiment, advertisements from merchants that have been favorited 630 are candidates for a push notification. This indicates that the user wants to specifically receive advertisement notifications regarding advertisements released by favorited merchants. The advertisement application 320 can store the advertisement from a favorited merchant and generate a push notification regardless of whether the merchant is in a selected category.

In some embodiments, users can specify a time period for receiving push notifications from advertisements. For example, the user may only want to receive push notifications for after work hours and indicates that in the user's preferences. At other times, the user may be busy and would be bothered by push notifications. When the client device 120 receives an advertisement from a favorited merchant, the time when the advertisement was received is matched 635 to the user-specified time period for receiving push notifications. Advertisements that match 635 the specified time period are used to generate a push notification to the user 640 while other advertisements are not used for generating push notifications 645.

### Computer Machine Architecture

FIG. 7 is a block diagram illustrating components of an example machine able to read instructions from a machine-readable medium and execute them in a processor (or controller) to implement the disclosed system for targeting specific users for publishing advertisements and customizing the selection of advertisements displayed. Specifically, FIG. 7 shows a diagrammatic representation of a machine in the example form of a computer system 700 within which instructions 724 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smart phone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processors 702 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 may further include graphics display unit 710 (e.g., a plasma display panel (PDP), a liquid crystal display (LCD), a projector, or a cathode ray tube (CRT)). The computer system 700 may also include alphanumeric input device 712 (e.g., a keyboard), a cursor control device 714 (e.g., a mouse, a trackball, a joystick, a motion sensor, or other pointing instrument), a storage unit 716, and a network interface device 720, which also are configured to communicate via the bus 708.

The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 110 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

### Additional Embodiments

The foregoing description of the embodiments has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a non-transitory computer-readable medium containing computer program instructions, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for pushing advertisements to a targeted group of users comprising:
receiving, from a merchant, an advertisement and conditions for publishing the advertisement to one or more users with an advertisement application installed on their device, the advertisement application having been configured to restrict advertisements from blocked categories and generate push notifications for one or more selected merchants;
monitoring one or more conditions associated with the received instructions;
based on one or more conditions associated with the received instructions being met, transmitting the advertisement to each user;
monitoring actions performed by each user in response to receiving the transmitted advertisement;
generating real-time tracking and analytics based on the monitored actions performed by each user; and
transmitting the generated real-time tracking and analytics to the merchant device.

2. The method of claim 1, further comprising:
transmitting, at predefined intervals of time, a request to each user for location information;
receiving, from each user, location information associated with where the user is located;
based on the received location information, generating a map displaying the real-time location of each user; and
transmitting the map to the merchant device for display.

3. The method of claim 2, wherein the generated map is restricted to an area proximate to the merchant's store location.

4. The method of claim 1, wherein the advertisement comprises one or more of the following: advertisement name, location, time, quantity, fine print, logo, associated images, links and associated advertisements.

5. The method of claim 1, wherein the conditions for publishing the advertisement comprises one or more of the following: a specified location where one or more users located in the specified location can receive the transmitted advertisement, a predefined time for transmitting the advertisement, or a selected subset of the one or more users to receive the transmitted advertisement.

6. The method of claim 1, wherein monitoring actions performed by each user further comprises:
receiving a time and location associated with a viewing and redemption of a transmitted advertisement by each user; and
logging the received time and location in association with the user.

7. The method of claim 6, further comprising:
receiving an indication that a user wants to redeem an advertisement;
determining whether advertisements are still available for redemption; and
based on the determination, transmitting a redemption indicator to the user, the redemption indicator comprising a QR code, barcode or redemption message.

8. A method for filtering received advertisements from merchants comprising:
receiving an advertisement from a merchant, the advertisement being published to one or more users when conditions specified by the merchant are met;
retrieving a set of user preferences, the user preferences having been predefined by the user;
determining whether to save an advertisement based on the retrieved set of user preferences;
based on the first determination, saving the advertisement for display to the user;
determining whether to generate a push notification for the saved advertisement based on the retrieved set of user preferences; and
based on the second determination, generating a push notification to alert the user of the saved advertisement.

9. The method of claim 8, further comprising:
receiving a first request from the user for displaying a saved advertisement;
responsive to the received first request, retrieving the saved advertisement;
displaying the retrieved advertisement to the user;
recording a detected time and location associated with the first request;
receiving a second request from the user for redeeming the displayed advertisement;
recording the time and location associated with the second request;
transmitting the recorded times and locations associated with the first and second requests to a server for analysis, the server configured to generate real-time tracking and analytics based on the received information;
transmitting a request for redeeming the displayed advertisement; and
receiving a response to the transmitted request for redeeming the advertisement, the response indicating whether the advertisement is redeemed.

10. The method of claim 8, wherein the set of user preferences comprises one or more of the following: a user specified location, selected categories, selected merchants, blocked categories and preferred time period for receiving push notifications.

11. The method of claim 10, wherein saving an advertisement is based on the received advertisement targeting the user specified location, being from a merchant within a selected category and being from a merchant that is not blocked.

12. The method of claim 10, wherein generating a push notification is based on the saved advertisement being from a selected merchant during the preferred time period specified by the user.

13. The method of claim 8, wherein the push notification comprises one or more of the following: a visual alert, an audio alert or a vibration.

14. A non-transitory computer readable storage medium storing computer program instructions executable to perform steps comprising:
receiving, from a merchant, an advertisement and conditions for publishing the advertisement to one or more users with an advertisement application installed on their device, the advertisement application having been configured to restrict advertisements from blocked categories and generate push notifications for one or more selected merchants;
monitoring one or more conditions associated with the received instructions;
based on one or more conditions associated with the received instructions being met, transmitting the advertisement to each user;
monitoring actions performed by each user in response to receiving the transmitted advertisement;
generating real-time tracking and analytics based on the monitored actions performed by each user; and
transmitting the generated real-time tracking and analytics to the merchant device.

15. The computer readable storage medium of claim 14, further comprising:
transmitting, at predefined intervals of time, a request to each user for location information;
receiving, from each user, location information associated with where the user is located;
based on the received location information, generating a map displaying the real-time location of each user; and
transmitting the map to the merchant device for display.

16. The computer readable storage medium of claim 15, wherein the generated map is restricted to an area proximate to the merchant's store location.

17. The computer readable storage medium of claim 14, wherein the advertisement comprises one or more of the following: advertisement name, location, time, quantity, fine print, logo, associated images, links and associated advertisements.

18. The computer readable storage medium of claim 14, wherein the conditions for publishing the advertisement comprises one or more of the following: a specified location where one or more users located in the specified location can receive the transmitted advertisement, a predefined time for transmitting the advertisement, or a selected subset of the one or more users to receive the transmitted advertisement.

19. The computer readable storage medium of claim 14, wherein monitoring actions performed by each user further comprises:
receiving a time and location associated with a viewing and redemption of a transmitted advertisement by each user; and
logging the received time and location in association with the user.

20. The computer readable storage medium of claim 19, further comprising:
receiving an indication that a user wants to redeem an advertisement;
determining whether advertisements are still available for redemption; and
based on the determination, transmitting a redemption indicator to the user, the redemption indicator comprising a QR code, barcode or redemption message.

21. A method for pushing content items to a targeted group of users comprising:
receiving, from a merchant, a content item and conditions for publishing the content item to one or more users with a content processing application installed on their device, the content processing application configured to restrict content items from blocked categories and generate push notifications for one or more selected merchants;
monitoring one or more conditions associated with the received instructions;
based on one or more conditions associated with the received instructions being met, transmitting the content item to each user;
monitoring actions performed by each user in response to receiving the transmitted content item;
generating real-time tracking and analytics based on the monitored actions performed by each user; and
transmitting the generated real-time tracking and analytics to the merchant device.
